(19) United States
(12) Patent Application Publication
(10) Pub. No.: US 2004/0001458 A1
(43) Pub. Date: Jan. 1, 2004

(54) Method and apparatus for facilitating a fair access to a channel by participating members of a group communication system

(75) Inventors: Jheroen P. Dorenbosch, Paradise, TX (US); Rich Bennett, Southlake, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/183,201

(22) Filed: Jun. 27, 2002

(51) Int. Cl. H04Q 7/00

(52) U.S. Cl. 370/329; 370/437

(57) ABSTRACT

To facilitate fair access to a channel, a controller (200) adds a member-specific channel-access delay, including adding at least one of a first member-specific delay (308) to a transmission of a free channel indication from the controller to a member (118-128) after the channel becomes free; and a second member-specific delay (314) before processing a request to talk received by the controller from the member. The controller selects (302) the member-specific channel-access delay such that a time required for the member to gain access to the channel after the channel becomes free is essentially equal to the time required for any other participating member to gain access to the channel after the channel becomes free.

### FIELD OF THE INVENTION

This invention relates in general to wireless communication systems, and more specifically to a method and apparatus for facilitating a fair access to a channel by participating members of a group communication system.

### BACKGROUND OF THE INVENTION

In dispatch (push-to-talk) group calls, a central controller manages and arbitrates a call. The controller manages the voice and the call control messages. In large systems, group calls can span multiple areas, causing differing delays in handling call control messages for different group members. Such differing delays can create a strong bias against remote members, making it difficult for them to gain access to the channel when they wish to talk.

Thus, what is needed is a method and apparatus for facilitating a fair access to a channel by participating members of a group communication system, when the members are subject to differing transmission delays while communicating with a controller of the group communication system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electrical block diagram of a prior-art group communication system.

FIG. 2 is an electrical block diagram of an exemplary controller in accordance with the present invention.

FIG. 3 is a flow diagram depicting operation of the exemplary controller in accordance with the present invention.

### DETAILED DESCRIPTION

In overview form the present disclosure concerns communications systems that provide service to communications units or more specifically users thereof operating therein. More particularly various inventive concepts and principles embodied in methods and apparatus to facilitate and assist in the fair and largely equal access to the communications system and services thereof regardless of varying system delays for different users are discussed and described. The communications systems of particular interest are those being deployed and developed such as IDEN systems or variations and evolutions thereof that are suitable for or use dispatch forms of communications. As further discussed below various inventive principles and combinations thereof are advantageously employed to assess relative delays among users or members and equalize or compensate therefore, thus alleviating various problems associated with known systems while still facilitating large system membership and capacities when appropriate, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

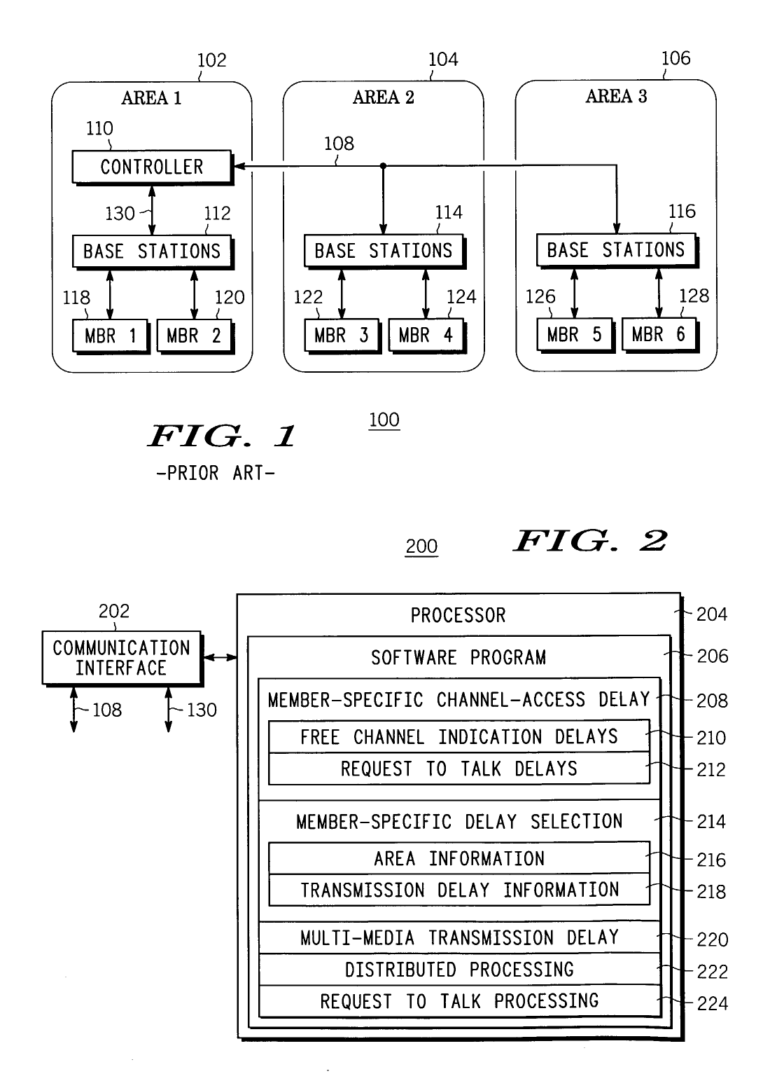

Referring to FIG. 1, an exemplary electrical block diagram of a prior-art group communication system 100 for dispatch (push to talk) type of communications will be discussed and described. The system 100 comprises a controller 110 coupled to a plurality of base stations 112, 114, 116 for communicating with a plurality of members 118-128, e.g., mobile stations, on a radio channel. The controller 110 is located in a first area 102, and communicates with the base stations 112 through, for example, a local area network (LAN) 130. The controller 110 further communicates with the base stations 114, 116 in second and third areas 104, 106 through, for example, a wide area network (WAN) 108. In particular, the controller 110 distributes a “free channel” indication whenever the channel is available for a next speaker to use. The indication is done, for example, by indicating silence in the voice stream, or by forwarding a free channel indication message to the group members 118-128.

Communicating through the LAN 130 and the WAN 108 can cause differing delays in the propagation of the free channel indication. This implies that some free channel indications will be sent to the members 118, 120 through the LAN 130 in the same area 102 as the controller 110, while other free channel indications will be sent to the members 122-128 in other areas 104, 106. The other free channel indications are sent across the WAN 108, and will likely travel via additional system entities (not shown) in the other areas 104, 106. This will lead to different delays in the delivery of the indication for different group members.

As is typical of modern communications systems members 118-128 who want to talk on the channel must send a request to talk message to the controller 110. When multiple requests to talk messages are sent from multiple members, an arbitration algorithm in the controller 110 processes the requests, usually on a first-come, first-served basis. Again, the time it takes for such a message to reach the controller 110 depends on the location of the member. When two members send a request to talk immediately after they receive a free channel indication, the request from a member with a larger delay will arrive at the controller 110 after the request from a member with a smaller delay. A controller 110 that does not compensate for this problem will create a strong bias against remote members, such as the members 126, 128, and hence will provide unfair access.

Referring to FIG. 2, an electrical block diagram of an exemplary controller 200 according to the present invention will be discussed and described. The controller 200 is similar in function to the controller 110 of the communication system 100, the essential difference being that the controller 200 incorporates new elements and the principles and concepts in accordance with the present invention. It will be appreciated that the controller functionality may be distributed over several entities or centrally deployed. For example, separate entities can manage voice stream distribution and call control. Before describing the controller 200 in detail, it will be helpful to discuss some general techniques that can be used for facilitating a fair access to the channel by the participating members 118-128, when the members 118-128 are subject to differing transmission delays.

One technique for compensating for different delays for different members 118-128 is to arrange for the controller 200 to send the free channel indication messages in a well-defined order. That is to say the controller 200 sends the free channel indications to the members in order of decreasing round-trip delay estimate. To do so, the controller 200 need to first obtain a round-trip delay estimate for each member.

There are several ways to obtain the round-trip delay estimate. A first way is for the controller 200 to use information about the area 102-106 of the member. If the area is the area 102 of the controller 200 itself, the delay is short, if it is a different area 104, 106 the delay is longer. For each area, the controller 200 preferably stores an average delay value. Alternatively, the controller 200 can take WAN loads for traffic to the area into account. The controller 200 preferably measures delays to each area by intermittently pinging an entity, e.g., one of the base stations 112-116 in each area, and by storing the ping roundtrip time.

The pinging may be done by sending an IP ping message to the entity. Alternatively, the controller 200 can ping by sending any other message to the entity that requires a response. Conveniently, many dispatch protocols require such messages during call setup, so that the pinging can be done without causing any overhead. For an even more accurate implementation, the controller 200 can measure roundtrip delays to the individual member mobile stations 118-128. This implementation will also take into account the over-the-air delays in the area where the member mobile station is located. If the mobile station supports IP, the controller 200 can again use an IP ping message. The controller may also use one of the messages supported by the dispatch protocol that requires a response from the mobile station, such as paging messages, other messages associated with call setup, authentication requests and status or capability queries. Furthermore, some dispatch protocols allow the measurement of the propagation time of the voice stream from the controller to the member mobile stations 118-128. The measured propagation times can then be doubled to estimate the round trip delays. Other techniques to measure delays can be used as well, such as calculating the round-trip delay from known geographic coordinates of the controller 200 and the base stations 112-116, along with parameters of the transmission paths.

The controller 200 can further improve fairness for members that have the same roundtrip delay estimate. It can do so by varying the order of the free channel indications it sends to such members for consecutive free channel occurrences for the same call. The variation can be, for example, round-robin or random.

In one embodiment, the controller 200 further improves fairness by introducing a compensatory delay before sending the free channel indication to some of the members 118-128. The compensatory delay value (CDV) for a member depends on the estimated roundtrip delay (ERD) for the member. The first free channel indication is sent without any delay, to a first member with the largest estimated roundtrip delay. The compensatory delay values are such that if all members send a request to talk immediately after they receive the free channel indication, the requests to talk arrive at the controller 200 at essentially the same time. The compensatory delay value for member i with respect to the first indication then should be: CDVᵢ=ERDᵢ−ERD_{first}.

The above embodiment has a drawback. It inserts compensatory delays in the outbound path. The free channel indications (e.g., beeps) are given to the listeners at such a time that when they respond immediately after receiving the indication, they have equal access. However, the free channel indication is not the only stimulus received by the listeners. The listeners also receive the voice of the talker. Normally the voice stream will also indicate—in a less formal way—that the channel has become available. For example, the talker may ask: “How much is two plus two?” and release the push-to-talk button. This by itself may trigger a response from the listeners. Since the voice stream is not delayed, this will give an advantage to the listeners with a short delivery delay, even if the free channel indication to those users is delayed.

In another embodiment, the controller 200 can delay the voice stream for each member by the same amount as the free channel indication. This will provide the same delay at all listeners between the end of the voice stream and the reception of the free channel indication. A disadvantage of this variation is that it is costly to provide the buffers needed for the compensatory voice stream delays. A further disadvantage is that it is complex to tune the buffers to the correct delay. A third disadvantage is that delays in the voice stream are undesirable from the user's point of view.

In yet another embodiment, the technique is not to insert compensatory delays in the free channel indications nor in the voice stream, but to insert the compensatory delays into the requests to talk, before the arbitration algorithm processes them. A request to talk from a member with a short round trip is delayed by the largest amount; a request to talk from the member with the longest round trip preferably is not delayed at all. After the compensatory delays have been applied, the arbitration processor can process the requests as they come in, for example on a first-come, first-served basis.

Inserting compensatory delays into the requests to talk is the preferred embodiment. One advantage is that the natural timing between the end of the voice stream and the free channel indication is retained and constant throughout the system. Another advantage is that there is less need to send free channel indications in a well-defined order. A third advantage is that voice is distributed with the minimum possible delay. A fourth advantage is that the number of request to talk messages generally is less than the number of free channel indications, so less processing is required for this embodiment. A fifth advantage is that the compensatory delays do not have to be known at the start of the call, but only after the first speaker is finished. This provides extra time to estimate these delays.

The delay insertion can be done in several ways: For example, the controller 200 can capture a request to talk; start a timer with the correct delay value; and

retransmit the request to the arbitration algorithm when the timer expires.

Alternatively, the controller 200 can capture each request to talk, tag it with a compensated_time equal to the current_time+compensatory_delay, and then offer the tagged request to the arbitration algorithm, where the arbitration algorithm will arbitrate based on the compensated_time and will only do so after the current_time is later than the earliest compensated_time. It will be appreciated that other variations for inserting the delay will occur to one of ordinary skill in the art, given the teachings of the instant disclosure.

The controller 200 can further improve call quality when it sets up the call by paging target members in a well-defined order, and optionally can insert compensatory delays in the paging messages to the members. The controller 200 can base order and delays on information for the member's area, or on measured roundtrip times for the members in earlier calls to those members.

It will be appreciated that, alternatively, part or all of the ordering and compensation can be done at remote system entities in a distributed manner. This is particularly appropriate if some of the coordination and distribution of the free channel indications is done by the remote system entities. The controller 200 can inform the remote system entities of the delays to be used. In addition, the controller 200 can use a single delay for all members in the same remote area in order to reduce overhead.

With that explanation of differing delays and compensation therefore and again referring to FIG. 2, the controller 200 in accordance with the present invention comprises a communication interface 202 for communicating channel access information with participating members of a group communication system through the LAN 130 and the WAN 108. “Participating members,” as used herein, means members who are provided fair access in accordance with the present invention. It is generally expected that most members using the group communication system are participating members. A non-participating member can be, for example, a dispatch leader who is intentionally assigned a delay-free channel access for supervisory or other purposes.

The controller 200 further comprises a processor 204 coupled to the communication interface 202 for processing the channel access information. The processor 204 comprises a software program 206 for programming the processor 204 to provide fair access to a channel by the participating members of the group communication system, even though the members are subject to differing transmission delays when communicating with the controller 200.

The software program 206 comprises a member-specific channel-access delay element 208 for programming the processor 204 to add a member-specific channel-access delay to the channel access by each participating member. The member-specific channel-access delay comprises at least one of (1) a first member-specific delay to a transmission of a free channel indication from the controller 200 to a member after the channel becomes free; and (2) a second member-specific delay before processing a request to talk received by the controller 200 from the member. As disclosed herein above, the preferred embodiment utilizes only the second member-specific delay. It will be appreciated that alternative embodiments in accordance with the present invention can utilize only the first member-specific delay, or a combination of the first and second member-specific delays.

The member-specific channel-access delay element 208 includes a free channel indication delays element 210 and a request to talk delays element 212. These elements preferably program the processor 204 to store the member-specific delays appropriate for a group call, once the group call is in progress. The software program 206 further comprises a member-specific delay selection element 214 for programming the processor 204 to select the member-specific channel-access delay such that a time required for the member to gain access to the channel after the channel becomes free is essentially equal to the time required for any other participating member to gain access to the channel after the channel becomes free. The process of selecting the member-specific channel-access delay preferably is performed as described herein above. It should be appreciated that, as herein defined, the time required for the participating member to gain access to the channel is exclusive of the reaction time required, for example, for the member to activate a push-to-talk button after hearing a beep indicating that the channel is free.

The member-specific delay selection element 214 includes an area information element 216 for programming the processor 204 to select the channel-access delay based upon the area in which the corresponding member is located. The member-specific delay selection element 214 also includes a transmission delay information element 218 for programming the processor 204 to select the channel-access delay based upon delay information measured for the corresponding member, through known techniques as discussed herein above.

The software program 206 further comprises a multi-media transmission delay element 220 for programming the processor 204 to add the first member-specific delay to a multi-media transmission, e.g., voice, sent to the member. This can be desirable, as described herein above, when the first member-specific delay is added to the transmission of the free channel indication, as well. In addition, the software program includes a distributed processing element 222 for programming the processor 204 to process the channel access information for the group communication system in a distributed manner through known techniques. The software program 206 also includes a request to talk processing element 224 for programming the processor 204 to arbitrate amongst the request to talk messages received from the members such that, after adjustment in accordance with the present invention, the request to talk messages are processed on a first-come, first served basis, through known techniques.

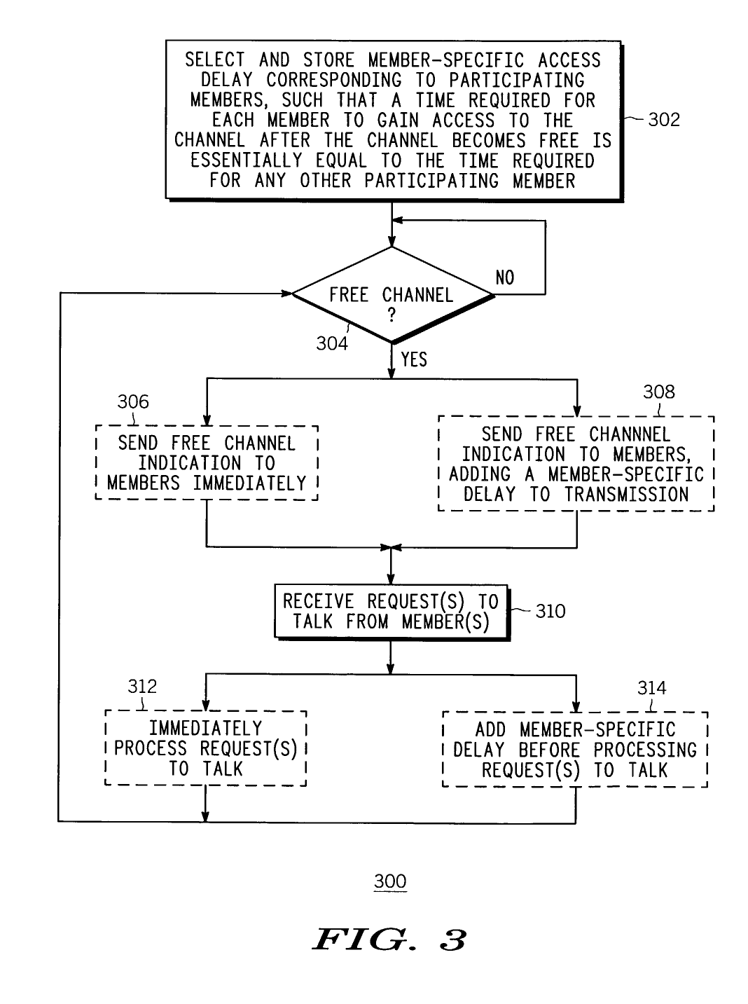

Referring to FIG. 3, a flow diagram 300 depicting operation of the exemplary controller 200 in accordance with the present invention begins with the controller 200 selecting 302 and storing a member-specific access delay corresponding to participating members, the delay selected such that the time required for each member to gain access to the channel after the channel becomes free is essentially equal to the time required for any other participating member to gain access to the channel after the channel becomes free. This step is preferably initiated at the start of each group call, and is preferably completed before the channel becomes free for the first time after communication has begun.

The controller 200 then waits 304 for the channel to become free. When the channel becomes free, the controller 200 preferably immediately sends 306 a free channel indication to the members taking part in the call. In an alternative embodiment, the controller 200 can send 308 the free channel indication to the members, adding a member-specific delay, in accordance with the present invention, to the transmission of the indication. The controller 200 then receives 310 request(s) to talk from the members(s) who wish to talk. The controller then preferably adds 314 a member-specific delay to the request(s) to talk, in accordance with the present invention, before processing the request(s) to talk. In the alternative embodiment, the controller 200 immediately processes 312 the request(s) to talk. In either case, the flow then returns to step 304 to wait for the channel to become free again. It will be appreciated that in yet another embodiment, both step 308 and step 314 can be employed when desired for flexibility or for some other reason.

Thus, it should be clear from the preceding disclosure that the present invention provides a method and apparatus for facilitating a fair access to a channel by participating members of a group communication system, when the members are subject to differing transmission delays while communicating with a controller of the group communication system. Advantageously, the method and apparatus facilitates fair access without requiring a substantial increase in processing power.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for facilitating a fair access to a channel by participating members of a group communication system, the members subject to differing transmission delays when communicating with a controller of the group communication system, the method comprising in the controller:
adding a member-specific channel-access delay, comprising at least one of:
adding a first member-specific delay to a transmission of a free channel indication from the controller to a member after the channel becomes free; and
adding a second member-specific delay before processing a request to talk received by the controller from the member; and
selecting the member-specific channel-access delay such that a time required for the member to gain access to the channel after the channel becomes free is essentially equal to the time required for any other participating member to gain access to the channel after the channel becomes free.

2. The method of claim 1, wherein adding the member-specific channel-access delay comprises
adding only the first member-specific delay, and not the second member-specific delay.

3. The method of claim 1, wherein adding the member-specific channel-access delay comprises
adding only the second member-specific delay, and not the first member-specific delay.

4. The method of claim 1, further comprising
adding the first member-specific delay to a multi-media transmission sent to the member.

5. The method of claim 1, wherein selecting the member-specific channel-access delay is based upon an area where the member is located, with respect to the area where the controller is located.

6. The method of claim 1, wherein selecting the member-specific channel-access delay is based upon a transmission delay between the controller and the member.

7. The method of claim 1, wherein adding the member-specific channel-access delay is performed in a distributed manner in at least two portions of the group communication system.

8. A controller for facilitating a fair access to a channel by participating members of a group communication system, the members subject to differing transmission delays when communicating with the controller, the controller comprising:
a communication interface for communicating channel access information with the members; and
a processor coupled to the communication interface for processing the channel access information,
wherein the processor is programmed to:
add a member-specific channel-access delay, comprising at least one of:
a first member-specific delay to a transmission of a free channel indication from the controller to a member after the channel becomes free; and
a second member-specific delay before processing a request to talk received by the controller from the member; and
select the member-specific channel-access delay such that a time required for the member to gain access to the channel after the channel becomes free is essentially equal to the time required for any other participating member to gain access to the channel after the channel becomes free.

9. The controller of claim 8, wherein the processor is further programmed to
add only the first member-specific delay, and not the second member-specific delay.

10. The controller of claim 8, wherein the processor is further programmed to
add only the second member-specific delay, and not the first member-specific delay.

11. The controller of claim 8, wherein the processor is further programmed to
add the first member-specific delay to a multi-media transmission sent to the member.

12. The controller of claim 8, wherein the processor is further programmed to
select the member-specific channel-access delay based upon an area where the member is located, with respect to the area where the controller is located.

13. The controller of claim 8, wherein the processor is further programmed to
select the member-specific channel-access delay based upon a transmission delay between the controller and the member.

14. A software program for facilitating a fair access to a channel by participating members of a group communication system, the members subject to differing transmission delays when communicating with a controller of the group communication system, wherein the software program, when installed and executing in the controller, causes the controller to:
add a member-specific channel-access delay, comprising at least one of:
a first member-specific delay to a transmission of a free channel indication from the controller to a member after the channel becomes free; and
a second member-specific delay before processing a request to talk received by the controller from the member; and
select the member-specific channel-access delay such that a time required for the member to gain access to the channel after the channel becomes free is essentially equal to the time required for any other participating member to gain access to the channel after the channel becomes free.

15. The software program of claim 14, further causing the controller to
add only the first member-specific delay, and not the second member-specific delay.

16. The software program of claim 14, further causing the controller to
add only the second member-specific delay, and not the first member-specific delay.

17. The software program of claim 14, further causing the controller to
add the first member-specific delay to a multi-media transmission sent to the member.

18. The software program of claim 14, further causing the controller to
select the member-specific channel-access delay based upon an area where the member is located, with respect to the area where the controller is located.

19. The software program of claim 14, further causing the controller to
select the member-specific channel-access delay based upon a transmission delay between the controller and the member.
